(19) United States
(12) Patent Application Publication
(10) Pub. No.: US 2004/0174028 A1
(43) Pub. Date: Sep. 9, 2004

(54) Device for holding a hot dish

(76) Inventor: Diane Lindley O'Bannon, Los Angeles, CA (US)

Correspondence Address: LADAS & PARRY, 5670 WILSHIRE BOULEVARD, SUITE 2100, LOS ANGELES, CA, 90036-5679, US

(21) Appl. No.: 10/383,349

(22) Filed: Mar. 6, 2003

(51) Int. Cl. B65G 7/00

(52) U.S. Cl. 294/33

(57) ABSTRACT

The present invention relates to an device for holding a dish, especially a microwave dish, including a spatula portion and a handle portion wherein the spatula portion includes a horizontal spatula member and a upright spatula member and the handle portion includes flexible moveable upper handle member relative to a lower handle member, so that a grasping member moves to a confronting position relative to the upright member. The microwave dish can be emptied on a plate and thrown away without touching the hot dish.

### BACKGROUND OF THE INVENTION

1. Field of Invention

This invention relates to a device for holding a hot dish, especially for a hot microwave dish, for removing it from the microwave oven.

2. Description of Prior Art

U.S. Pat. No. 2,705,166, discloses a pie plate holder comprising a fixed jaw, a moveable jaw pivotally secured to said fixed jaw and a handle separately pivoted to said fixed jaw, said moveable jaw having a hook portion for engagement with the inside rim of a pie pan only adjacent to the bottom thereof.

The plate holder was designed to work with many non-standard pie dishes and the hook designed to leave the piecrust undamaged. It is not suitable for removing a hot dish from a microwave oven. The design would destabilize a microwave dish when it is removed from the microwave oven.

U.S. Pat. No. 1,551,592 discloses a pan lifter. The pan lifter comprises a supporting member including spaced parallel arms adapted to extend beneath the bottom of a pan. The U-shaped portion, and a block carried thereby and constituting a handle, a cross rod extending between said arms, a retaining member pivotally mounted between its ends upon said cross rod, and provided at its one end with hooks disposed to take over the upper edge of the rim of the pan a finger button carried by the opposite end of said member, and spring means interposed between and connected with said button and block. The jaw of the pan lifter is not suitable for a microwave dish. The person using this tool for removing hot dishes from a microwave oven could easily get burned due to the design of the pan lifter.

### BRIEF SUMMARY OF THE INVENTION

One aspect of the present invention is to provide a device for holding a dish including a spatula portion and a handle portion wherein the spatula portion includes a horizontal spatula member and an upright spatula member and the handle portion includes a flexible moveable upper handle member relative to a lower handle member, so that a grasping member moves to a confronting position relative to the upright member.

Another aspect of the present invention is to provide a dish holder for removing a hot microwave dish from a microwave oven and to stabilize the hot microwave dish for safety. Another aspect of the present invention is to provide a dish holder, which is heat stable, flexible and light in weight. Another aspect of the present invention is to provide a dish holder, which has no links, screws or connection pieces. Another aspect of the present invention is to provide a process of holding a hot dish comprising:

Pushing the dish holder underneath a dish until the dish is positioned on the horizontal spatula member,

Pushing the flexible handle members and against each other from a relaxed position to a closed position, and

Pushing the upright wall of the dish by the grasping member against the upright spatula member.

Another aspect of the present invention is to provide a process of fixing and moving a hot dish according to claim 18 further comprising:

Taking the hot dish out of the oven,

Turning the dish holder and the fixed dish and empty said dish,

Relaxing the handle members and releasing the dish.

### BRIEF SUMMARY OF THE DRAWINGS

The drawings include FIG. 1a to FIG. 5.

FIG. 1a and FIG. 1b are a side view of the device for holding a microwave dish. FIG. 1a depicts the dish holder in the relaxed form. FIG. 1b depicts the dish holder in the closed position.

FIG. 2 is a top view of the dish holder.

FIG. 3 is a side view of the dish holder.

FIG. 4 is the down side of the dish holder.

FIG. 5 is a front view of the dish holder.

### DETAILED DESCRIPTION OF THE INVENTION

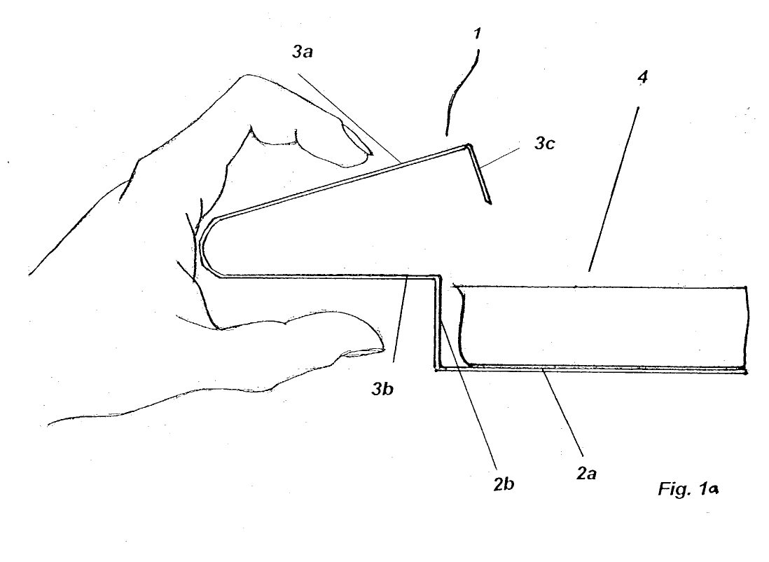

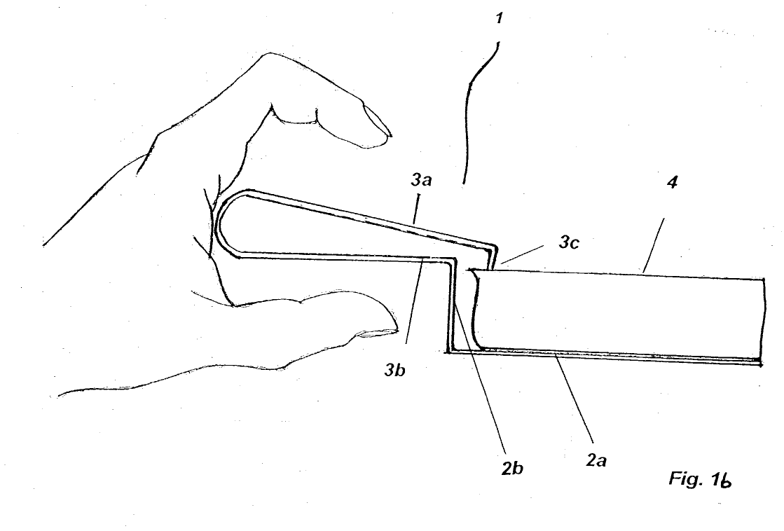

FIGS. 1a and 1b depict the device for holding hot dishes, in this invention also called a dish holder, which includes a spatula portion 2 and a handle portion 3. The handle portion 3 includes two handle members 3a and 3b, which are connected flexibly, so they can be pushed against each other. The handle portion 3, further includes a grasping member 3c. When the two handle members 3a and 3b are pushed together, the grasping member 3c grabs the dish 4, hereinafter also called microwave dish 4, which has to be held tight. The dish 4 is in a tight hold position by pushing the wall of the dish 4 by the grasping member 3c towards the upright spatula member 2b.

FIG. 1a, shows the handle portion 3 in the resting position and in this position the spatula member 2 can be pushed underneath the microwave dish 4 to bring the dish into a position wherein its upright wall is adjacent to the upright spatula member 2b. Position 1b, shows the dish holder 1 with the handle portion 3 in the pinched closed position. After the dish 4 is brought into the right position on the horizontal spatula member 2a, the handle members 3a and 3b are pushed together. The grasping member 3c thereby fixes the dish 4 on the horizontal spatula member 2a and pushes the wall of the dish 4 against upright spatula member 2b.

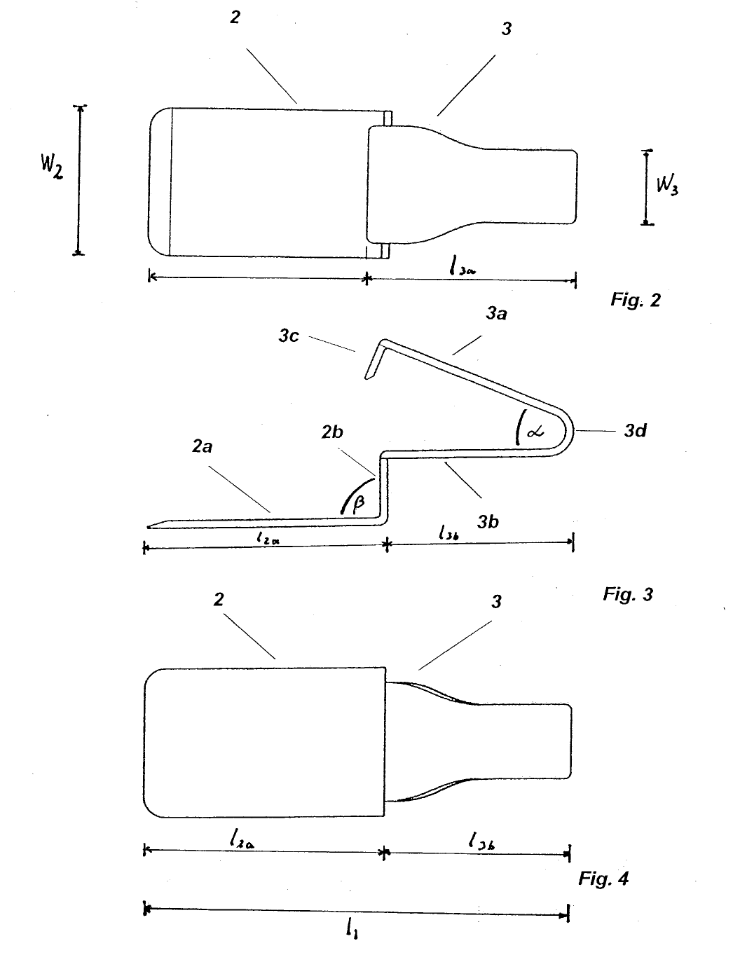

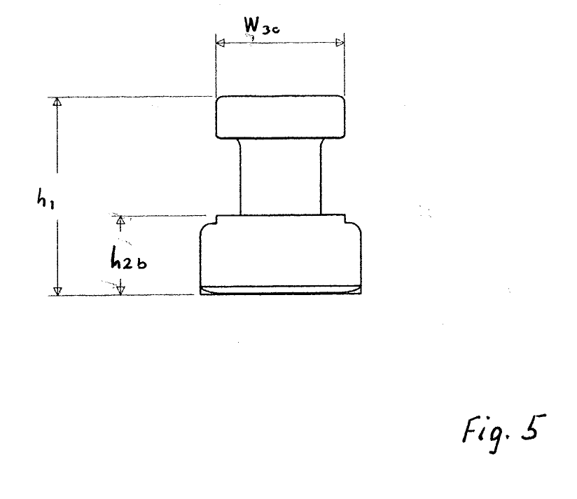

According to a preferred embodiment of the invention, the grasping member 3c, because of its width is vital to stabilize the hot microwave dish 4 for safety. This is shown in FIG. 2. The dish holder 1 is preferably designed for use with a particular industry produced microwave dish 4. It is made of flexible materials, like iron, iron alloys, polymers, copolymers and block copolymers with no need for screws for other complicated devices to function correctly. It is easily cleaned and dishwasher safe. It is designed for one-handed use. It is safe and easy to use, preferably with a specific product like a microwave dish 4. A typical microwave dish 4 is about one to two inches in height. The fact that this dish holder 1 is fabricated with a deep drop handle makes it a much more effective tool due the stability of the dish holder compared with known dish holders. The user never needs to directly touch the hot dish surface at all when taking it from the oven or while serving from the dish 4 to a plate or throwing the dish 4 in the trash, for dishes which are meant to be used only once. The dish holder 1 is designed to stand on its horizontal spatula member 2a, leaving the grasp member 3c of the handle 3 ready to accept the user's hand without fumbling.

The angle β between the horizontal spatula member 2a and the upright spatula member 2b in combination with the grasping member 3c enables the dish holder to secure the dish 4 as shown in FIG. 1a, FIG. 1b and FIG. 3.

The dish holder 1 is preferably manufactured of thermoplastic polymers by injection molding in an integrated unit. The product, for which this tool is designed specifically, is preferably a designed microwave dish 4. A large number of people are using the industry standard microwave dishes 4 including children and handicapped people.

The dish holder 1 has an angle β between the horizontal and the upright spatula members 2a and 2b of 80°-100°, preferably 85°-95°, most preferably 89°-91°. The dish holder 1 does not require any tabs. Finally, the dish holder does not require a pivotal handle.

The dish holder 1 has a length 1₁ of 13 cm-25 cm, preferably 16 cm-22 cm and most preferably 17 cm-19 cm long.

The spatula portion 2 has a length 1₂ₐ of 7 cm-13 cm, preferably 8 cm-12 cm and most preferably 9 cm-11 cm and a width w₂ of 4 cm-9 cm, preferably 5 cm-8 cm and most preferably 5 cm-7 cm.

The handle portion 3 has a length 1₃ₐ and 1_{3b} of 6 cm-12 cm, preferably 7 cm-11 cm and most preferably 8 cm-10 cm and a width w₃ of 2 cm-6 cm, preferably 1.5 cm-4 cm and most preferably 2.5 cm-3.5 cm in the bending area 3d.

The width w_{3c} of the handle portion 3 is 4 cm-7 cm, preferably 4.5 cm-6.5 cm and most preferably 4.8 cm-5.5 cm at the grasping member 3c.

The height h₁ of the device 1 is 6 cm-10 cm, preferably 7 cm-9 cm and most preferably 7.5 cm-8.5 cm.

The height h_{2b} of the grasping member 2b is 2 cm-5 cm, preferably 2.5 cm-4 cm and most preferably 2.8 cm-3.5 cm.

The handle portion 3 has an angle α between the portions 3a and 3b in the bending area 3d of 10°-90°, preferably 15°-30°, most preferably 20°-25°.

The device for holding dishes according to the present invention called dish holder 1 for hot dishes, preferably microwave dishes 4 should be made out of a flexible thermoplastic polymer and have most preferably the following measurements:

Dish holder 1: a length 1, of 17.9 cm,

Spatula portion 2: a length 1₂ₐ of 10.16 cm and 6.3 cm,

Handle portion 3: a length 1₃ₐ and 1_{3b} of 8.7 cm and 3.2 cm in the bend area 3d,

The angle β: between spatula portions 2a and 2b is about 90°,

The angle α: between the portions 3a and 3b in the bending area 3d is bout 23°.

1. A device for holding a dish including a spatula portion and a handle portion wherein the spatula portion includes a horizontal spatula member and an upright spatula member, the handle portion includes a flexible moveable upper handle member relative to a lower handle member, so that a grasping member moves to a confronting position relative to the upright spatula member.

2. The device for holding a dish according to claim 1 wherein the handle members are connected flexibly and can be pushed towards each other from a relaxed position to a closed position.

3. The device for holding a dish according to claim 1 wherein the grasping member pushes the upright wall of the dish against the upright spatula member when the two handle members are pushed together.

4. The device for holding a dish according to claim 1 wherein the device includes flexible materials like iron, iron alloys, polymers, copolymers and block copolymers.

5. The device for holding a dish according to claim 1 wherein the handle portion has an angle α between the members in the bend area of 10°-90°.

6. The device for holding a dish according to claim 1 including an angle β between the horizontal and the upright spatula members of 80°-100°.

7. The device for holding a dish according to claim 1 wherein the length 1₁ of the device is 13 cm-25 cm.

8. The device for holding a dish according to claim 1 wherein the length 1₂ₐ of the spatula portion is 7 cm-13 cm.

9. The device for holding a dish according to claim 1 wherein the width w₂ of the spatula portion is 4 cm-9 cm.

10. The device for holding a dish according to claim 1 wherein the length 1₃ₐ and 1_{3b} of the handle portion is 6 cm-12 cm.

11. The device for holding a dish according to claim 1 wherein the width w₃ of the handle portion is 2 cm-6 cm in the bend area.

12. The device for holding a dish according to claim 1 wherein the width w_{3c} of the handle portion is 4 cm-7 cm at the grasping member.

13. The device for holding a dish according to claim 1 wherein the height h₁ of the device is 6 cm-10 cm.

14. The device for holding a dish according to claim 1 wherein the height h_{2b} of the grasping member is 2 cm-5 cm.

15. The device for holding a dish according to claim 1 including flexible thermoplastic polymer and a spatula portion, having a length 1₂ₐ of 10.16 cm and width w₂ of 6.3 cm, a handle portion, having a length 1₃ₐ of 8.7 cm long and a width w₃ of 3.2 cm in the bend area, having an angle β between spatula portions of 90°.

16. Process of manufacturing a device according to claim 1 by injection molding of thermoplastic polymer.

17. Process of holding a hot dish comprising:
a) Pushing the dish holder underneath a dish until the dish is positioned on the horizontal spatula member,
b) Pushing the flexible handle members against each other from a relaxed position to a closed position, and
c) Pushing the upright wall of the dish by the grasping member against the upright spatula member.

18. Process of fixing and moving a hot dish according to claim 18 further comprising:
d) Taking the hot dish out of the oven,
e) Turning the dish holder and the fixed dish and empty said dish,
f) Relaxing the handle members and releasing the dish.
